(19) United States
(12) Patent Application Publication
(10) Pub. No.: US 2024/0020750 A1
(43) Pub. Date: Jan. 18, 2024

(54) DYNAMIC USER INTERFACE FOR A NETWORK TRAFFIC SURGE RESISTANT PLATFORM

(71) Applicant: Fevo, Inc., New York, NY (US)

(72) Inventors: Vladimir Mitevski, New York, NY (US); Ari Daie, New York, NY (US)

(21) Appl. No.: 17/865,906

(22) Filed: Jul. 15, 2022

(51) Int. Cl. G06Q 30/06

(52) U.S. Cl. CPC G06Q 30/0635; G06Q 30/0641

(57) ABSTRACT

A system and method to manage a surge network traffic targeting a service-hosting platform are disclosed. For an offer of goods and/or services, the platform provider generates a static package that is placed in networked storage that is accessible through a web service interface. The package contains the information required to instantiate and render the interface of the service-hosting platform using the processor and resources of the computer that accesses the package via a browser. Based on the contents of the package, the rendered interface presents the services of the service-hosting platform using resources of the customer's computer without making any calls to a server to query a protected backend system. The interface may be refreshed from time-to-time without causing traffic directed at the service-hosting platform. Access to the protected backend resources and platform resources is gated by threshold actions taken by the user.

### RELATED APPLICATIONS

This application is related to U.S. Patent Application No. WW/WWW,WWW entitled “NETWORK TRAFFIC SURGE RESISTANT PLATFORM,” filed on the same day (Attorney Docket No. 48987-00102), U.S. Patent Application No. YY/YYY,YYY entitled “INVENTORY MANAGEMENT FOR A NETWORK TRAFFIC SURGE RESISTANT PLATFORM,” filed on the same day (Attorney Docket No. 48987-00104), U.S. Patent Application No. ZZ/ZZZ,ZZZ entitled “INVENTORY MANAGEMENT SYSTEM PROTECTION FOR NETWORK TRAFFIC SURGE RESISTANT PLATFORM,” filed on the same day (Attorney Docket No. 48987-00105), and U.S. Patent Application No. TT/TTT,TTT entitled “AUTHENTICATION MANAGEMENT FOR A NETWORK TRAFFIC SURGE RESISTANT PLATFORM,” filed on the same day (Attorney Docket No. 48987-00106), each of which is herein incorporated by reference in their entirety.

### TECHNICAL FIELD

The present invention is generally related to webhosting of electronic commerce and, more specifically, management of surge network traffic to an electronic commerce platform.

### BACKGROUND

Purchasing high demand goods and/or services, such as popular toys or event tickets, can be frustrating for consumers and potentially debilitating for electronic commerce platform providers. Increasingly, merchants use flash sales or other such events where all or part of the available inventory is, for a limited amount of time, offered to a group of people at a special price and/or is offered as an opportunity to purchase before the general public. Merchants may use such events to offer benefits to a particular group of customers (e.g., premium members, students, faculty, etc.), as a form of price differentiation, and/or to capture the attention of highly motivated customers, etc. Sometimes, instead of a preplanned event, consumer interest in a good or service is so high that a similar surge in traffic is generated upon an initial offer of the good or service. In such scenarios, instead of managing infrastructure (e.g., servers, databases, network bandwidth, etc.) for mean site traffic, the merchant's site must be configured to handle relatively infrequent surges of high network traffic volume that include a large number of requests into the merchant's backend infrastructure. For example, a flash sale can act like a denial of service attack, but where the entire traffic is legitimate. Often, backend systems, such as inventory management systems, are built with older technology that cannot handle the massive volume of queries into its databases. Such backend systems can be overwhelmed by these high traffic value events.

### SUMMARY

Systems and methods for providing an electronic commerce platform that manages surges of high network traffic volume while protecting backend computing resources are described herein. For an offer of goods and/or services, the platform provider generates a static package that is placed in networked storage (e.g., networked object storage, etc.) that is accessible through a web service interface. The package contains the information required to instantiate and render the interface of the store, as well as information that is necessary to complete a transaction. When the offer is electronically communicated via a link, the linked location on the merchant platform's server includes just enough HTML instructions to retrieve the package from the storage and instantiate the interface. Based on the contents of the package, the interface of the merchant platform is then rendered in the browser of the customer using the processor and resources of the customer's computer (e.g., not resources a server of the merchant platform). During this process, the graphical elements of the interface may be retrieved from the networked storage. Based on the contents of the package, the rendered interface presents available inventory and performs cart management (e.g., presenting available inventory, selecting/deselecting goods and/or services to be placed in the cart, etc.) using resources of the customer's computer without making any calls to a server to query an inventory management system. The interface only performs backend calls (e.g., calls to the merchant platform server, etc.) when necessary to complete the next stage of the transaction (e.g., after the customer takes an affirmative step in the transaction). For example, when the customer clicks on an action button that signals that they desire to proceed with checking out, a call to an inventory server to query the relevant inventory management system(s) is made to place a temporary hold on the desired inventory. The rendered interface collects information to authenticate the identity of the customer and collects payment information. The interface then performs backend calls to the relevant system (e.g., the payments system, the customer management system, etc.) to verify the customer's information and process the payment. After, the payment is processed and the customer is identified, the merchant platform makes a call to the inventory management system to reserve the goods and/or services for the customer.

The offer package specifies one or more quantity pickers to be included in the cart interface. The quantity picker(s) are a context aware interface element that provides an interface to facilitate the user to quickly select the desired goods and/or services with as few interactions with the interface and mechanics operating the interface as possible. While quantity pickers are effective on a cart interface operating in a browser on desktop, table, and/or laptop computer, quantity pickers are important on the cart interface being instantiated in browsers of mobile devices, such as smart phones and smart watches. For example, each quantity picker may define how it is rendered in the cart interface depending on the browser and/or the computing device on which the browser is executing. This allows the cart interface to be adaptive and facilitate user to quickly select the desired goods and/or services with as few interactions with the interface and mechanics operating the interface as possible given the special considerations, such as space considerations inherent on interfaces presented on mobile devices. Additionally, the offer package may be, from time-to-time, updated to change the look, feel and/or content of the offer. For example, the merchant may change the quantity picker and/or the goods associated with the offer. In such examples, the updated offer package is pushed to network storage asynchronously relative to any computer accessing the offer package. That is, the user receiving the updated offer package depends on the computer retrieving the updated offer package, not the commerce platform signaling that the offer package has been updated. Thus, updating the offer package does not increase network traffic directed to the commerce platform.

A network traffic surge resistant system includes network storage and one or more servers configured as a commerce platform. At a first time, the commerce platform generates a script, a first offer package, and an offer instantiator, and store the script and the first offer package onto the network storage. The offer instantiator provides the location of the script and the first offer package in the network storage. At a second time after the first time, the commerce platform generates a second offer package that is related to the first offer package and replaces the first offer package with the second offer package in the same location in the network storage. Generating the second offer package does not cause the commerce platform to generate an update signal to any browsers. In response to a browser operating on a computing device accessing the offer instantiator after the first time but before the second time: (i) the offer instantiator causes the browser to retrieve the script and the first offer package from the network storage, and (ii) the script causes the browser to instantiate a cart interface within the browser based on the first offer package using the resources of the computing device without making a backend call to the commerce platform. The cart interface includes an action button. In response to the browser accessing the offer instantiator after the second time: (i) the offer instantiator causes the browser to retrieve the second offer package from the network storage, and (ii) the script causes the browser to instantiate the cart interface within the browser based on the second offer package using the resources of the computing device without making a backend call to the commerce platform.

An example method for asynchronously updating a cart interface a network traffic surge resistant platform includes, at a first time: (i) generating, by one or more servers configured as the network traffic surge resistant platform, a script, a first offer package, and an offer instantiator, (ii) storing, by the one or more servers configured as the network traffic surge resistant platform, the script and the first offer package onto the network storage. The offer instantiator stores and provides the location of the script and the first offer package in the network storage. The method also includes, in response to a browser operating on a computing device accessing the offer instantiator after the first time but before a second time: (i) causing, by the offer instantiator, the browser to retrieve the script and the first offer package from the network storage, and (ii) causing, by the script, the browser to instantiate a cart interface within the browser based on the first offer package using the resources of the computing device without making a backend call to the commerce platform. The method includes, at the second time after the first time: (i) generating, by the one or more servers configured as the network traffic surge resistant platform, a second offer package that is related to the first offer package; and (ii) replacing, by the one or more servers configured as the network traffic surge resistant platform, the first offer package with the second offer package in the same location in the network storage. Generating the second offer package does not cause the commerce platform to generate an update signal to the browser. The method includes, in response to the browser accessing the offer instantiator after the second time: (i) causing, by the offer instantiator, the browser to retrieve the second offer package from the network storage, and (ii) causing, by the script, the browser to instantiate the cart interface within the browser based on the second offer package using the resources of the computing device without making a backend call to the commerce platform.

### BRIEF DESCRIPTION OF THE DRAWINGS

Operation of the present disclosure may be better understood by reference to the following detailed description taken in connection with the following illustrations, wherein:

FIG. 1 is a block diagram of an example system to provide an electronic commerce platform to manage a surge network traffic, according to the teachings of this disclosure.

FIG. 2 is a conceptual diagram of bricks used to construct a package used to manage the surge network traffic, according to the teachings of this disclosure.

FIG. 3 is a conceptual diagram of the packager of FIG. 1 generating an offer package, according to the teachings of this disclosure.

FIG. 4 is a conceptual diagram of the commerce platform of FIG. 1 publishing the offer package, according to the teachings of this disclosure.

FIGS. 5A and 5B illustrate example cart interfaces, according the teachings of this disclosure.

FIGS. 6A and 6B illustrate an example cart interface with a hierarchical organization, according to the teachings of this disclosure.

FIGS. 7A, 7B, and 7C illustrate example quantity pickers, according to the teachings of this disclosure.

FIG. 8 illustrates an example method of asynchronously updating an offer package, according to the teachings of this disclosure.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Commerce platforms that offer high demand and/or limited time offers for good and/or services often require backend systems (e.g., physical and/or virtual servers, databases, network bandwidth, etc.) that are deployed to meet or scale to surges in network traffic as a large number of customers simultaneously attempt to procure the goods and/or services. For example, platforms that handle ticket sales for major events (e.g., sports, concerts, etc.) often see such surges in network traffic as tickets are released. These surges can be orders of magnitude greater than the mean or ordinary network traffic and can overwhelm the commerce platform and its surrounding infrastructure with the flood of Internet traffic. Managing these sources can be costly and error prone, as it depends on recognizing the surge and differentiating the surge from illegitimate traffic (e.g., a denial of service attack, etc.). Additionally, in many cases, some backend systems, such as inventory management systems, are deployed using technology that is hard to scale (if even possible) and cannot handle the volume of requests necessary to service the traffic. For examples, generally scalability must be part of the design of a database and many inventory systems were deployed before scalability was required. This can lead to slowing, instability and/or termination of the operation of the ecommerce platform because the network and the backend system cannot cope or adapt quickly to the surge. Attempted techniques, such as queues and timed inventory reservation systems, etc., are often not effective in mitigating the effects of surge network traffic and can be used by malicious actors and/or undesirable consumers to deny some or all customers access to purchasing the good and/or services on the commerce platform. Accordingly, there are technical problems that prevent a commerce platform from being able to manage surges in network traffic volume without negatively affecting the backend systems that comprise the commerce platform.

As users react to newly offered good and services, the network of the commerce platform can experience increasingly intense waves of traffic as part of a traffic surge. These waves of network traffic can cascade on top of each to damage or otherwise impair operation of the servers and network hosting the commerce platform. Because some network traffic is necessary to finalize a purchase and, for example, instantiate payment widgets for a third party, an interface, especially on mobile device, that does not quickly and efficiently move a user through use of the commerce platform can compound this traffic. Thus, to help manage and minimize network traffic to not cripple the commerce platform, there is a need to provide one or more elements in the user interface that facilitate minimizing user interaction to select the good and/or services they desire and guide the user to completing their use (e.g., via a purchase or leaving the interface, etc.) of the commerce platform efficiently and with as few traffic generating events as possible.

Additionally, from time-to-time, the commerce platform will need to update the interface and/or the good and/or services being offered through the interface. For example, a good or service may need to be added or removed or an interface element may need to be changed to better facilitate minimizing user interaction to select the good and/or services they desire and guide the user to completing their use of the commerce platform efficiently and with as few traffic generating events as possible. However, because traditionally the interface is instantiated by the servers of the commerce platform and transmitted to the browser of the user, generating network traffic and server usage by the commerce platform, performing an update during these periods of traffic surge, when an update may most be needed, is impractical, if even possible, given the network traffic issues. Thus, there needs to be a way to update the cart and/or checkout interface during a traffic surge without generating more network traffic from or towards the commerce platform.

The term “server” has its ordinary meaning. Generally, a server provides computational services in a request—response model where, in response to a request (sometime referred to as a “call”) over a network, the server performs some computational action and sends a response back to the requesting computer. As used herein, a “backend call” refers a request by an interface operating on the computing device of a customer to a non-static network resource (e.g., a server, a database, etc.). A “backend call” generally requires the server(s) of the commerce platform to process the request and generate information to be sent to the requester that is responsive to the contents of the request. For example, the backend call may require a query into an inventory database to determine status of inventory associated with the offer. Though the intensity can vary, backend calls are relatively computationally intensive to network resources. The terms “network storage” and “cloud storage” have their ordinary meaning. Generally, network storage provides object storage through a web service interface to facilitate remote storage and retrieval of data objects. As used herein, a “static call” refers to a request to a static network resource, such as networked storage that stores data objects (e.g., visual elements for an interface, scripts to be executed by the interface, offer packages, etc.). Static calls are relatively computationally inexpensive. As used herein, an “offer instantiator” refers to a document designed to be processed in a web browser that includes (i) structure (e.g., written in HTML code, etc.) necessary to render a cart interface, (ii) a location of where to receive a related offer package (e.g., from networked storage), and (iii) a location to receive a instantiating script to render the cart interface using the structure and the offer package.

A merchant that desires to make an offer via a surge traffic resistant commerce platform (“commerce platform”) generates an offer package through the commerce platform. The offer package contains information necessary to render a cart interface and browse inventory associated with the offer without making backend calls to the commerce platform or any inventory management system tracking the inventory associated with the offer. The package may be, for example, generated in a data-interchange format. The packages is then stored on one or more static network storage devices. To communicate the offer, the commerce platform creates a link (e.g., a Uniform Resource Locator (URL), etc.) that points to an address that contains the location of the offer package, the location of the script to render the cart interface, and a minimum amount of code (e.g., HTML, etc.) necessary to use the script to render the cart interface.

When a consumer activates the link, the consumer's browser fetches the offer package and the script to render the cart interface (e.g., by generating browser readable code, etc.) on the commuting device executing the browser. That is, instead of a server (e.g., one of the servers of the commerce platform) generating the cart interface and then sending the browser readable code defining the cart interface to the browser, the computing device of the customer generated the browser readable code for the cart interface using the script and based on the offer package. In such a manner, when a surge of customers are simultaneously or near simultaneously interacting with the cart interface, a corresponding serge of traffic is not generated directed at the servers of the commerce platform and those servers are not overwhelmed by the resulting processing to generate and update the cart interface. The cart interface includes an action button. The browser generated cart interface performs pre-checkout cart management functions using the resources of the browser without making inventory or checkout related backend calls to the servers of the commerce platform until the action button is activated (e.g., “clicked on”) by the customer. These pre-checkout cart management functions include browsing inventory (e.g., names, descriptions, and/or prices of inventory available through the offer, etc.), receiving an indication of the type and/or quantity that the customer desires to purchase, and/or calculating an estimated total cost of the indicated type and quantity. Because the package includes all of the inventory information (e.g., offer details, identities and descriptions of inventory available with the offer, price, etc.), the cart interface performs these pre-checkout functions without making any backend calls. Thus, a surge of customers browsing inventory, many of whom are not likely to complete a purchase, does not create a corresponding surge in network traffic or server load for the commerce platform. From time-to-time, the commerce platform may asynchronously regenerate the offer package to change any part of the offer, including available inventory, the theme or template, etc., to replace the previous package at the same location in the static network storage. Thus, the merchant may dynamically update the cart interface without causing a surge of network traffic or server load.

When the customer activates the action button, the browser renders, based on the offer package, a checkout interface and makes a backend call that includes the identities and quantities of the inventory in the current cart of the cart interface. This backend call causes one of the servers to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each change results in the backend call to calculate the total cost of the items. These price calculations are performed without querying the inventory management system of the merchant. Thus, a large number of such backend calls does not result in an increased load on the merchant's inventory management system. In some examples, these backend calls are configured to be computationally light to reduce any strain on the servers of the commerce platform.

When the browser receives the calculation, the checkout interface displays the total. The checkout interface performs a redirect to a payment processor. In some examples, this causes the payment processor to instantiate one or more payment electronic widgets (e.g., a Google® Pay widget, an Apple® Pay widget, etc.) and/or a credit card payment widget in the checkout interface. Interacting with one of the electronic payment widgets or the credit card payment widget (e.g., providing payment credentials, etc.) causes the payment processor to generate a payment intent that places a hold on funds equal to the calculated amount. Up to this point, the merchant platform does not make any call to the inventory management system of the merchant. After the payment processor signals that the payment intent was successful, the commerce platform attempts to place a reserve on the items with the inventory management system of the merchant. When the inventory management system signals that the attempt to reserve the inventory was successful, the commerce platform initiates one or more authenticity/security checks (sometimes referred to as “authorization challenges”) with the customer via the checkout interface. When all of the authenticity/security checks are successful, the commerce platform requests that the inventory management system place the reserved items in a fulfillment status. The commerce platform then signals the payment processor to complete the transaction based on the purchase intent. The commerce platform then performs post-purchase fulfillment actions via the checkout interface. In such a manner, the commerce platform minimizes network traffic, server load, and load on the inventory management system by only generating such activity when the customer has affirmatively signaled their desire to complete a transaction and only to the extent necessary for their current level of commitment.

When generating the offer package, the merchant may select a quantity picker brick that specifies an interface element that is instantiated within the cart interface by the user's browser. As used herein, the interface element specified by the quantity picker brick may be referred to as a “quantity picker.” Different quantity picker bricks may have different forms that have user interface advantages in different circumstances. The quantity picker is a context aware interface element that is configured to facilitate minimizing user interaction to select the goods and/or services they desire and guide the user to completing their use of the commerce platform efficiently and with as few traffic generating events as possible. The quantity picker brick may specify the form and function of the quantity picker to be included in the offer package that changes depending on the device on which the browser instantiating the cart interface is operating. For example, a quantity picker may be rendered in one form when rendered by a browser operating on a computing device and may be rendered in a different form when rendered by a browser operating on a mobile device. In some examples, a quantity picker may be assigned to all of the goods and/or services specified by the offer package (e.g., the browser renders the same quantity picker for each good and/or service, etc.). In some examples, the quantity picker may be assigned to each good and/or service individually such that different goods and/or services in the same offer package may be associated with different quantity pickers.

From time-to-time, the merchant may need to update the offer package to, for example, update interface elements, themes, templates, descriptions, and/or goods and/or services offered in the cart and/or checkout interfaces. The system, as described below, asynchronously updates the offer package and pushes the updated offer package to network storage regardless of and without sending an update signal to computers instantiating the cart interface. The computers instantiating the cart interface retrieve the updated offer package to instantiate the updated cart interface upon re-accessing the offer instantiator. Because no positive signal is sent from the commerce platform, updating the offer package does not generate more traffic on the network directed at the commerce platform. Thus, the offer package and the cart interface can be updated even in the middle of a surge of network traffic directed towards the commerce platform.

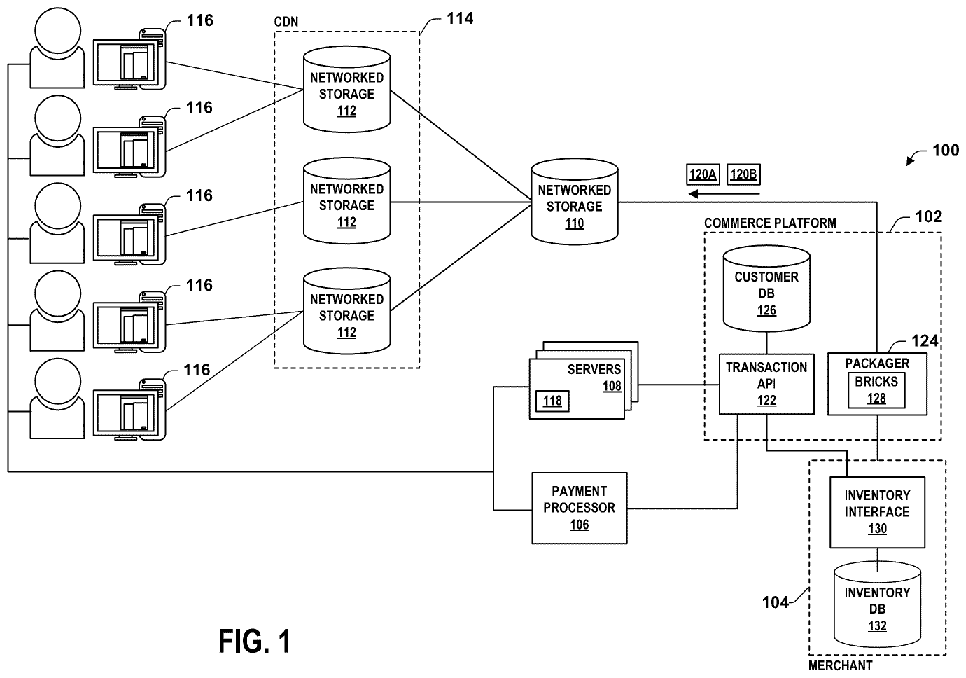

FIG. 1 is a block diagram of an example system 100 to provide an electronic commerce platform 102 to manage a surge network traffic. In the illustrated example, the commerce platform 102 is communicatively coupled merchant networks (e.g., merchant network 104) and payment processors 106. The commerce platform 102 is also communicatively coupled to one or more webservers 108 (e.g., physical servers, virtual servers, and/or virtualized containers, etc.) and one or more network storage devices 110 (e.g., Amazon® S3, Google® Cloud Storage, Azure® Blob Storage, IBM® Cloud Object Storage, etc.). Data objects stored in the network storage devices 110 may be pushed onto network storage devices 112 that are part of a content delivery network (CDN) 114 to be accessed by browsers operating on computing devices 116 (e.g., desktop computers, laptop computers, smart phones, tablets, smart televisions, etc.). The commerce platform 102 facilitates generation of offer instantiators 118, offer packages 120A and 120B (collectively “offer packages 120”), and instantiator scripts by a merchant to offer goods and/or services managed by the merchant network 104 though the commerce platform 102. One offer package 120A may be generated at a first time and another related offer package 120B (e.g., a modified version of the first offer package 120A) may be generated at a second time after the first time. The commerce platform 102 may regenerate and publish (e.g. send to the network storage 110 to be distributed to the network storage 112 of the CDN 114) the offer package 120B regardless of whether or not the prior offer package 120A is being accessed on the network storage 110 and 112 and/or one or more of the computing devices 116 are using the prior offer package 120A to instantiate the cart interface based on the prior offer package 120A. Additionally, upon generating the updated offer package 120B, the commerce platform 102 does not communicate any signals directly to the computing devices to inform the computing devices 116 that the updated offer package exists. However, in some examples, if the user tries to perform an action through the cart and/or checkout interfaces that is supported by the prior offer package 120A but is not supported by the updated offer package 120B, (i) the script used to instantiate the interfaces may automatically re-access the offer package (and thus receive the updated offer package 120) and/or (ii) the commerce platform 102 may then signal that the offer package 120A is outdated.

The commerce platform 102 includes a transaction application programming interface (API) 122, a packager 124, and a customer database 126. While in the illustrated example, the transaction API 122, the packager 124, the customer database 126, and the webservers 108 are illustrated as being conceptually grouped in a certain configuration for simplicity, these components may be otherwise situated in any suitable manner (e.g., on cloud servers, etc.). The transaction API 122 facilitates communication between the webservers 108, the payment processor 106, the merchant network 104, and the customer database 126. The packager 124 receives input from the merchant to generate the offer instantiator 118 and the offer package 120 using software bricks 128. In some examples, the package 124 generates the offer package 120 in a data-interchange format (e.g., JavaScript Object Notation (JSON), Extensible Markup Language (XML), YAML, etc.). The software brick 128 are offer package components that define the parameters, metadata, available inventory and/or audiovisual assets of the offer and the interrelationship between these parameters, metadata, available inventory and/or audiovisual assets. The Customer database 126 stores customer information to facilitate assigning an order from a checkout interface in a browser to a particular account or accounts for security and fulfillment purposes. The structure and organization of the offer package 120 are dictated by which bricks are used to generate the offer package 120.

Using the packager 124, the merchant defines the offer and provides an inventory data object (e.g., a two dimensional array, etc.) that specifies the available inventory for the offer and attributes of the inventory the merchant uses to distinguish the inventory. For example, the data object may include a row for each seat in a venue that is to be part of the offer and a column for the section, a column for the row, a column for the seat. The packager 124 generates a unique link (e.g., a URL link, etc.) that instructs a browser where to locate the offer instantiator 118. The offer package 120 contains the information necessary for an instantiating script referenced by the offer instantiator 118, when accessed by a browser, to render the cart interface and the checkout interface, including a description of the available inventory to facilitate a customer browsing the inventory through the cart interface without making any backend calls to the webservers 108 and/or the transaction API 122. After the offer instantiator 118, instantiating script, and offer package 120 are created, the packager 124 publishes the instantiator 118 onto the webservers 108 and pushed the offer package 118 and the instantiator script onto the networked storage 110 and 112. The link to the instantiator 118 may then be provided to customers. In the illustrated example, the instantiator 118 is located on a server and is accessible via a domain that is controlled/operated by the commerce platform 102. Alternatively, in some examples, the offer instantiator 118 may be located on a server and accessible via a domain that is controlled/operated by another party (e.g., the merchant network 104, a third party, etc.).

The merchant may, from time-to-time, rebuild the offer package 120A with new and/or updated parameters, metadata, available inventory and/or audiovisual assets of the offer. When the offer package 120A is rebuilt, the packager 124 pushes the updated offer package 120B to replace the old offer package 120A in the networked storage 110 and 112. In such a manner, the merchant can dynamically and asynchronously update the offer package 120B while customers access the offer instantiator 118 without interruption. After the updated offer package is 120B pushed to the networked storage 110 and 112, the computing devices 116 instantiate the updated cart interface in the browser when they access the offer instantiator 118. This facilitates a merchant using the packager 124 to generate the updated offer package 120B, and thus an update cart interface, without generating increased network traffic and/or without modifying the content of the servers 108 in the middle of a surge of network traffic.

The example merchant network 104 includes an inventory interface 130 and an inventory database 132 (collectively may be referred to as an “inventory management system” or “IMS”). The inventory interface 130, using the inventory database 132, provides the inventory data object. The inventory interface 130 may also manipulate the inventory in the inventory database 132 by, for example, changing the status of the inventory (e.g., reserving the inventory, marking the inventory for fulfillment, etc.). In some examples, the inventory interface 130 may limit the frequency at which the packager can request a refresh of the inventory data object.

When a consumer activates the link to the offer instantiator 118, the consumer's browser performs a static call to retrieve the offer package 120 and the script to render the cart interface (e.g., by generating browser readable code, etc.) from the network storage 110 and 112. The browser then renders the cart interface by executing the script using the offer package 120. The browser generated cart interface performs pre-checkout cart management functions using the resources of the browser. These pre-checkout cart management functions include browsing inventory (e.g., names, descriptions, and/or prices of inventory available through the offer, etc.) as defined by the inventory data object (e.g., as processed by the bricks 128).

When the customer activates the action button, the browser renders, based on the offer package 120, a checkout interface and makes a backend call that includes the identifiers (sometimes referred to as “inventory unit identifiers) that identify inventory in the current cart of the cart interface and quantities of the inventory in the current cart of the cart interface. This backend call causes one of the servers 108 to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each changes results in the backend call to the servers 108 to calculate the total cost of the items.

When the browser receives the calculation, the checkout interface displays the total. The checkout interface performs a redirect to the payment processor 106. In some examples, this causes the payment processor 106 to instantiate one or more payment electronic widgets (e.g., a Google® Pay widget, an Apple® Pay widget, etc.) and/or a credit card payment widget in the checkout interface. Successfully credentialing through one of the electronic payment widgets or the credit card payment widget causes the payment processor 106 to generate a payment intent that places a hold on funds equal to the calculated amount. After the payment processor 106 signals that the payment intent was successful, the transaction API 122 attempts to place a reserve on the items with the inventory management system. When the inventory management system signals that the attempt to reserve the inventory was successful, the transaction API 122 initiates one or more authenticity/security checks with the customer via the checkout interface. When all of the authenticity/security checks are successful, the transaction API 122 requests that the inventory management system place the reserved items in a fulfillment status. The transaction API 122 then signals the payment processor 106 to complete the transaction based on the purchase intent. The transaction API 122 then performs post-purchase fulfillment actions via the checkout interface.

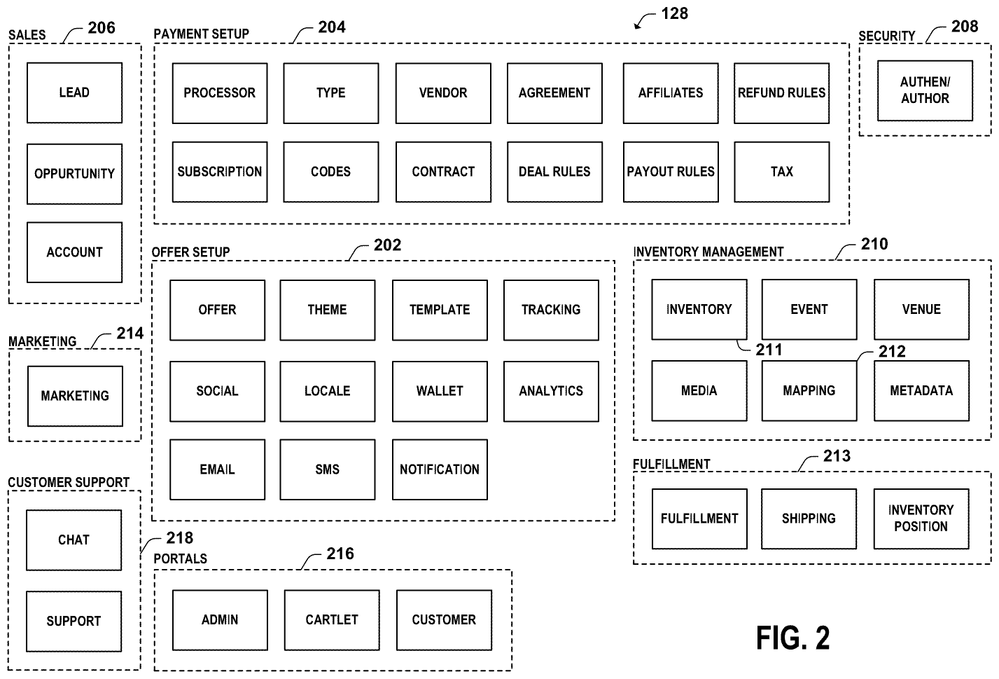

FIG. 2 illustrates examples of the bricks 128 used to define and construct the offer package 120. The bricks 128 are software structures that define the parameters, metadata, available inventory and/or audiovisual assets of the offer, the interrelationship between these parameters, metadata, available inventory and/or audiovisual assets, and the syntax of the data interchange format in which the package 120 is being created. When creating the offer package, the merchant may select the relevant bricks 128 to define the look and feel, the functionality, inventory management and grouping, and the order flow associated with the cart interface that is rendered using the offer package 120 constructed using the bricks 128 selected and populated by the merchant. The bricks 128 facilitate building the offer package 120 so to include the necessary parameters, metadata, available inventory and/or audiovisual assets of the offer and/or tokens point to the parameters and/or metadata to perform front end actions (e.g., the computing device 116 rendering the cart interface for the offer) and to perform backend actions (e.g., handle payment, refunds, fund allocation, customer service, etc.). In the illustrated example, the bricks 128 are arranged in thematic groups. However, the bricks 128 may be arranged in any manner. For example, when the packager 124 packages the selected bricks 128 into the offer package 120, the resulting structure of the offer package 120 mirrors the bricks 128. In some examples, the bricks 128 define interface elements that translate the structure of the bricks into interactable objects within a interface to design an offer. The interactable objects have inputs that facilitate receiving the information necessary to render the component of, for example, the cart interface and define relationships between the bricks 128. As such, as bricks 128 are added to an offer, a corresponding interface in an offer editor is generated.

In the illustrated example of FIG. 2, a group of bricks 128 is classified in an offer setup group 202. The bricks 128 in the offer setup group 202 are used to build the look and feel of the cart interface as well as the operation of the cart interface related to the specific offer. A group of bricks 128 is classified in a payment setup group 204. The bricks 128 in the payment setup group 204 are used to define rules for a transaction made of the specific offer and establish a transactional route and history for every good and/or service purchased through the offer. A group of bricks 128 is classified in a sale group 206. The bricks 128 in the sales group 206 interface with external to connect offers to the merchant and facilitate merchant account management. The offer setup group 202, the payment setup group 204, and the sales group 206 contribute structure and metadata to the offer package 120 to facilitate forensically tracing and justifying any transaction that is made according to the offer package 120 and to supply a system with information to complete a transaction while minimizing the transaction's use of backend calls.

In the illustrated example, a group of bricks 128 is classified in a in a security group 208. Bricks 128 in the security group 208 provide parameters and metadata for performing the multiple security check to authenticate a customer and check if the customer is authorized to perform the transaction. A group of bricks 128 is classified in an inventory management group 210. Bricks 128 in the inventory management group 210 provide parameters and metadata for slicing and presenting inventory in the cart interface and interfacing with the inventory management system of the merchant. An inventory brick 211 provides a connector between the packager 124 and the IMS of the merchant 104 (sometimes referred to as an “adapter”). The inventory brick 211 includes, for example, specific API calls and limitations and/or parameters for those calls for the specific IMS of the merchant 104. In some examples, the packager 124 may include multiple inventory bricks 211 when multiple merchants 104 and/or multiple IMSs are involved in the offer. The inventory brick 211 retrieves or otherwise receives a one or more two dimensional tables that describe inventory to be made available in the offer. A mapping brick 212 receives the one or more two dimensional tables and facilitates the merchant 104 and/or the commerce platform 102 into slicing the rows of the two dimensional table(s) to define the available inventory in a manner to be included in the offer package 120 such that (a) the corresponding inventory is arranged/organized in the cart and/or checkout interface, and (b) inventory has an appropriate quantity picker assigned in the cart and/or checkout interface, etc. A group of bricks 128 is classified in a fulfillment group 213. Bricks 128 in the fulfillment group 128 provide parameters and metadata for fulfilling and delivering inventory after a successful transaction. A group of bricks 128 is classified in a marketing group 214 to provide support to attributing sales of goods and/services to parties involved in completing the transaction (e.g., first party or third party sales agents, etc.). A group of bricks 128 is classified in a portals group 216. Bricks 128 in the portals group 216 provide top level structure to packages, including the offer package 120. A group of bricks 128 is classified in a customer support group 218 that includes structure, parameters, and metadata to render a customer support interface and to process customer support requests while minimizing the number of backend calls the customer's browser performs.

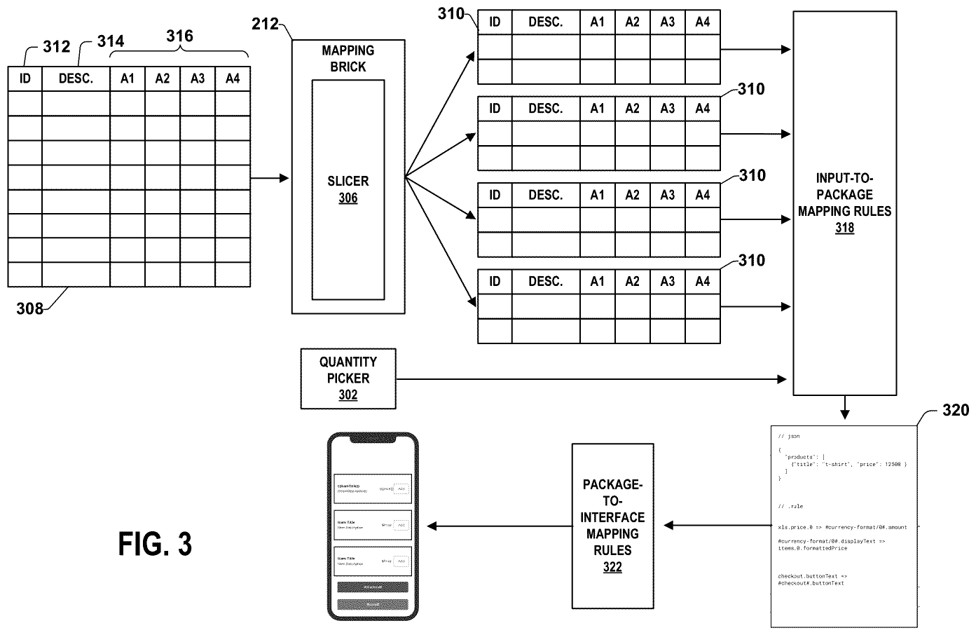

FIG. 3 is a conceptual diagram of the packager 124 of FIG. 1 generating the offer package 120. The packager 124 uses a plurality of bricks 128 to define the content of the offer package 120 and the structure of the offer package 124 that will be used to instantiate the cart and checkout interfaces using the resources of the computing devices 116 of the user accessing the corresponding offer instantiator 118. The merchant 102 interaction with the packager 124 through a packager interface that facilitates editing of the contents and structure of the offer package 120. The packager interface includes selectors to facilitate selection of which bricks 128 (and, for example, which subbricks, etc.) to use to generate the offer package 120 and edit the parameters and metadata associated with each of the selected bricks 128. These selectors may be graphical elements that are dragged and moved in the packager interface to select the bricks 128 and to define relationships between the bricks 128. For example, the bricks 128 may specify different widgets, different quantity pickers 302, different themes, different templates, define audio and/or visual assets to be used, and/or different ways to slice inventory, etc. (collectively referred to as “elements”). For example, the widgets define interactive interface elements in the cart interface that causes the hosting browser to perform an action that reaches externally from the browser (e.g., make a backend call, make a call to the payment processor 106, etc.). For example, one widget may define the parameters (e.g., size, shape, position, label, etc.) of the action button. As another example, one widget may define which third party payment processor to send information to facilitate instantiation of the payment processor's payment interface in the checkout interface.

In the illustrated example of FIG. 3, the mapping brick 212 includes a slicer 306. The slicer 306 facilitates transforming a two-dimensional table 308 of the inventory to be included in the offer package 120 into slices of inventory 310 that have common attributes and are to be organized in the cart interface together with and each associated with a quantity picker 302 (sometimes referred to as “variants”). The slices 310 may further be subdivided by the slicer 306 to form a hieratical set of sliced inventory, for example in a tree structure, where the bottom leaves are assigned a quantity picker 302. The two-dimensional table 308 includes a unique identifier 312 for each inventory item or class of inventory item. For example, fungible items and/or services (e.g., such as clothing, consumables, etc.) may have an identifier that is associated with all items of the class, while non-fungible and/or pseudo-fungible and/or limited edition goods or services have unique identifiers. The two-dimensional table 308 includes a description 314 that provides a human-readable description of the goods. The two-dimensional table 308 includes attributes 316 that distinguish the goods in some way (e.g., descriptively, such as color, location, quality, etc.) and/or organizationally (such as discounts, relations, intangible quantifier, etc.). The slicer 306 transforms the two-dimensional table 308 into the slices of inventory 310 based on the attributes 316 as designated via the mapping brick 212 by the merchant.

In the illustrated example of FIG. 3, the packager 124 includes input-to-package mapping rules 318 that transform the widgets (e.g., the quantity picker(s) 302), other elements (e.g., themes, templates, and/or audio and/or visual assets to be used, etc.), and, in the illustrated example, the inventory slices 310 into a data interchange formatted file 320 for the offer package 120. The mapping rules 308 map the sliced inventory 310, in quantity pickers 302, and other information defined by and through the bricks 128 (e.g., the widgets 304 and the elements 306, etc.) into syntax of the data interchange format such that all of the data required to build the cart interface and the checkout interface, all of the data to perform cart management functions (e.g., displaying inventory being offered, prices, and descriptions; manipulating quantities in the cart; estimating total price, etc.) are included in the offer package 120.

In the illustrated example, the data interchange formatted file 320 is processed with package-to-interface rules 322 that specify how the elements will be graphically laid out by the cart interface and/or checkout interface based on, for example, the selected theme and template bricks and the target browser in which the interfaces will be created. For example, the data interchange formatted file 320 may be processed by different sets for package-to-interface rules 322 to generate different versions of the offer package 120, where the offer initiator 120 causes the browser to download one of the versions of the offer package 120 based on the qualities of the browser. For example, a set of package-to-interface rules 320 may generate one offer package 120 for browsers operating on mobile devices (e.g., smart phones, smart watches, etc.), one offer package 120 for browsers operating on computing devices (e.g., desktop computers, tablets, laptop computers, etc.), and one offer package for browsers operating on mixed reality devices (e.g., virtual reality headsets, augmented reality headsets, etc.). Because the input-to-package rules 318 are processed separately from the package-to-interface mapping rules 322, the rules sets 318 and 322 can be updated asynchronously. That is, the template bricks may be updated and the update will be implemented the next time the offer package 120 is published.

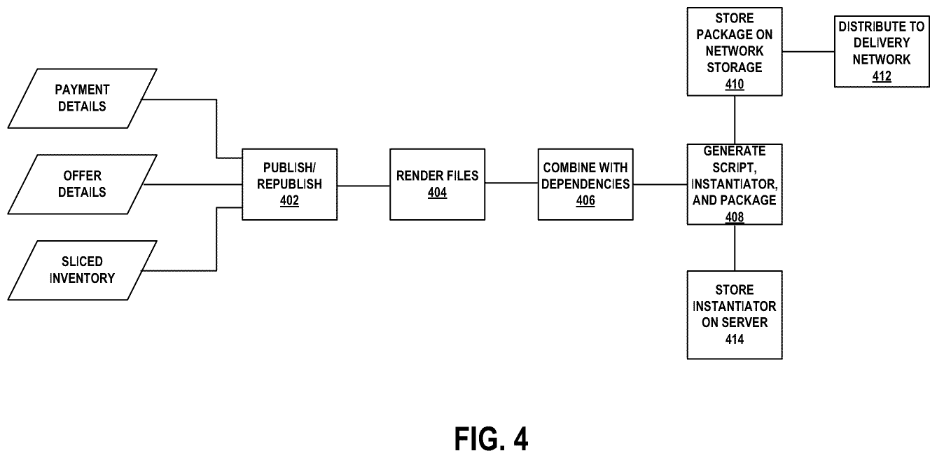

FIG. 4 is a conceptual diagram of the commerce platform 102 of FIG. 1 publishing the offer package 120 and the offer instantiator 118. The commerce platform 102 may asynchronously republish the offer instantiator 118 and the offer package 120 without regard to computing devices 116 instantiating the cart and/or checkout interface. At block 402, the entity using the commerce platform 102 (e.g., the merchant 104, etc.) indicates that the offer instantiator 118 and/or the offer package 120 should be published or republished. For example, a “publish” button may be provided in the packager interface. At block 404, the packager 124 renders the offer package 120. In some examples, the packager 124 renders the offer package 120 in accordance to the process described in connection with FIG. 3 above. The packager 124 may perform this rendering multiple times to generate offer packages 120 to be used by different browsers. At block 406, the packager 124 retrieves dependencies that are specified by the bricks 128 used to create the offer package 120. The dependencies may be, for example, libraries, audio and/or visual files (e.g., as designated by the selected template brick, the selected theme brick, and/or the selected quantity picker brick, etc.), and/or link paths (e.g., URLs, etc.), etc. Because bricks 128 can be updated asynchronously, dependencies that may have changed since the last time the offer package 120 was published automatically have those dependencies updated in an offer package when it is republished. At block 408, the packager 124 generates the offer package(s) 120, the script 121 used by the browser to generate the cart and checkout interfaces, and the offer instantiator 118 to be distributed. In some examples, the packager 124 may perform versioning of the offer package(s) 120 and the script 121 each time the offer package(s) is/are republished. The offer instantiator 118 may be changed to point the browser to the updated script and/or updated offer package(s) 120 when the browser refreshes. At block 410, the packager 124 stores the script, the offer package(s) 120, and/or any assets necessary to render the cart interfaces to the network storage 110. To prevent network traffic, especially to a large number of applicable computing devices 116, the packager 124 does not notify any of the computing devices 116 operating browsers in which the cart and/or checkout interface is instantiated that the offer package 120 is being published/republished. At block 412, the package 124 causes the script 121, the offer package(s) 120, and/or the assets to be distributed to the networked storage 112 in the CDN 114. In some examples, the packager 124 sends a signal to the CDN 114 invalidating the current cache, which causes the network storage 112 in the CDN 114 to update to the latest files. At block 414, the offer instantiator 118 is moved the server(s) 108 to me accessed by the computing devices 116.

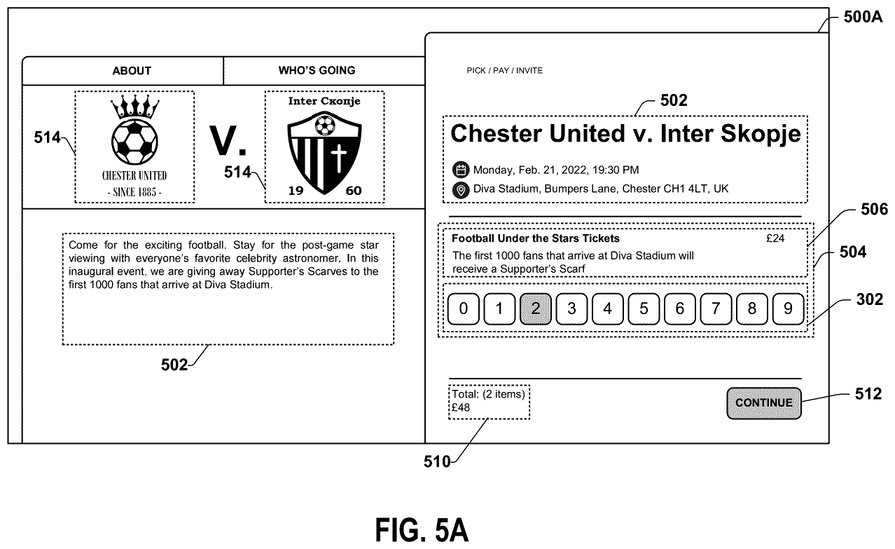

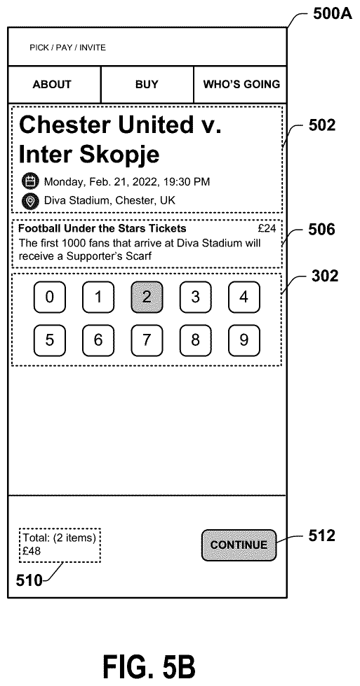

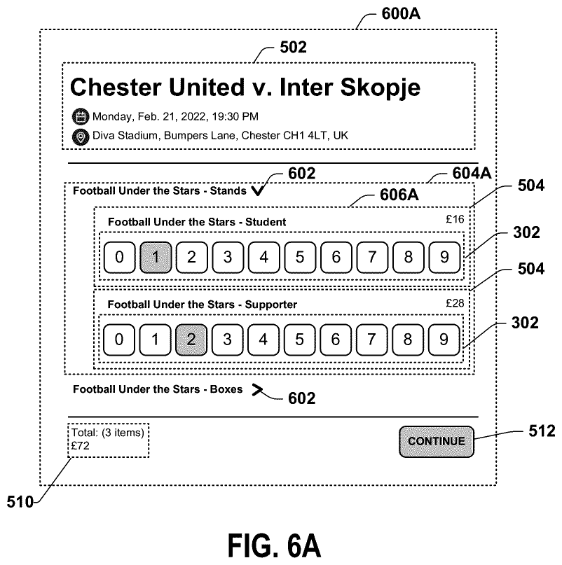

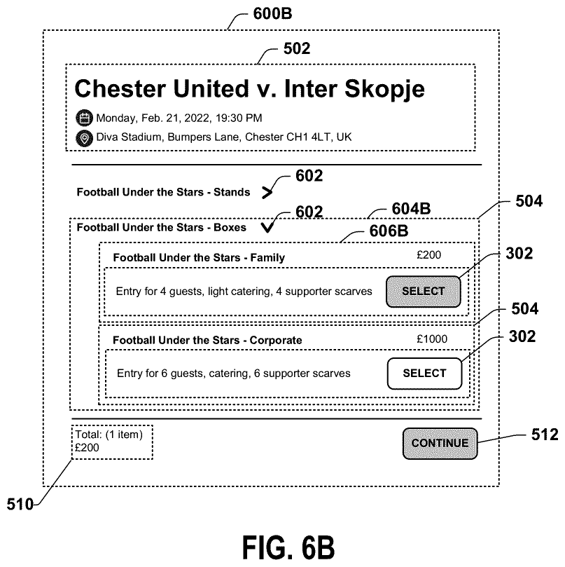

FIGS. 5A, 5B, 6A, and 6B illustrate example cart interfaces 500A, 500B, 600A, and 600B generated by a browser, operating on a computing device 116, in response to being directed to the offer instantiator 118. The offer instantiator 118 directs the browser to the instantiating script and the offer package 120 to use when instantiating the cart interfaces 500A, 500B, 600A, and 600B. In the illustrated examples of FIGS. 5A, 6A, and 6B, the offer instantiator 118 causes the browser to fetch the instantiating script and/or offer package 120 to use to instantiate the cart interfaces 500A for in a desktop browser. In the illustrated example of FIG. 5B, the offer instantiator 118 causes the browser to fetch the instantiating script and/or offer package 120 to use to instantiate the cart interfaces 500B in a mobile browser. In the illustrated examples of FIGS. 5A and 5B, the cart interfaces 500A and 500B have the same elements 302, 502, 504, 506, 510, 512, and 514 that are rearranged and contextualized, by the script and/or the contents of the offer package 120 to use the resources of the computing device 116 available to the browser. For example, the elements 302, 502, 504, 506, 510, 512, and 514 of the cart interface 500B of FIG. 5B are differently arranged compared to the elements 302, 502, 504, 506, 510, 512, and 514 of the cart interface of FIG. 5A to present the same information in a manner that takes into account the limited space on which to display an interface on a mobile device. Once the offer package 120 is loaded in a browser, the instantiating script generates instructions and makes the necessary calls to instantiate the cart interface 500 and perform cart management functions without making a backend call. From time-to-time, the offer package 120 and/or the instantiating script may be updated without the browser receiving a signal and/or instructions from, for example, the commerce platform 102. The browser updates the cart interface 500 in response to an event that causes the browser to re-fetch the offer package 120 and/or the script (e.g., the user instructing the browser to refresh, etc.).

In the illustrated example, the cart interface 500 includes high level description 502 of the inventory and an inventory item 504 for each piece of inventory being offered. In some examples, each of the inventory items 504 represent one of the sliced inventory 310. While for illustrative purposes, only one inventory item 504 is shown, cart interface 500 may include as many inventory items 504 as are defined in the offer package 120.

In some examples, because the sliced inventory 310 may be defined in a hierarchical order in the offer package 120, the offer package 120 and the script may instantiate the cart interface with the inventory items 504 displayed in a matching nested or hierarchical manner. In the illustrated examples of FIGS. 6A and 6B, the cart interface 600A and 600B includes the inventory items 504 rendered in a hieratical manner according to the inventory slices 310. The inventory item 504 includes a description 506 of the inventory being offered as well as the associated quantity picker 302. As illustrated in FIGS. 6A and 6B, goods may be initially displayed as a list of categories of goods that, when an interface element 602 is clicked, reveal the individual available inventory items 504 corresponding to the inventory slices 310 that are defined to be in that level of the hierarchy. For example, for event tickets, the cart interface 500 may initially display sections, where each row within a section is an inventory item 504. In the illustrated example of FIGS. 6A and 6B, the inventory item 504 are grouped in a first level 604A and 604B of a hierarchical tree and a second level 606A and 606B of the hierarchical tree. In the illustrated examples, the inventory items 504 in in each of the first levels 604A and 604B is associated with a different type of the quantity picker 302 because, for example, the characteristics of the inventory items 504 is in each of the first levels 604A and 604B are different. All of the information necessary to construct the cart interface 600A and 600B with the inventory items 504 organized in such a heretical manner is included in the offer package 120 such that instantiating the cart interface 600A and 600B does not require a backend call.

When the quantity of items in the quantity picker 302 is changed, the browser, without making a backend call, estimates the total amount based on the information in the offer package 120 and displays the estimated total in the total field 510. Because this calculation is done entirely within the browser: (a) the calculation is quick, and (b) the manipulation of the inventory in the cart interface 500 does not result in traffic being directed to the commerce platform 102 and does not result in any queries into the IMS of the merchant 104. Using the script 121, based on the offer package 120, this cart management is repeated until the customer interacts with the action button 512. In this manner, the customer may browse the inventory items 504 and add items to the cart without any traffic being directed at the commerce platform 102.

The look and feel of the cart interface 500 is dictated by the selected template brick and the selected theme brick. The template brick dictates how the script 121, in conjunction with the offer package 120, generates code to define the layout of elements 502, 504, 506, 302, 510, 512, and 514 within the cart interface 500. If, during block 402 of FIG. 4, the merchant were to select a different template brick or the template brick definition changed (e.g., changes that would take effect in block 406 of FIG. 4), when the customer refreshes the browser, the script 121, in conjunction with the offer package 120 would generate a changed layout. The selected theme brick dictates the aesthetic look and feel (e.g., color, audio visual assets 512, etc.). If, during block 402 of FIG. 4, the merchant were to select a different theme brick or the theme brick definition changed (e.g., changes that would take effect in block 406 of FIG. 4), when the customer refreshes the browser, the script 121, in conjunction with the offer package 120 would generate a different look and feel of the cart interface 500.

The cart interface 500 is different from the checkout interface. The cart interface 500 does not, until the action button 512 is interacted with, provide a method for the browser, during the course of the user browsing the inventory, to perform backend calls. Thus, in the cart interface 500, selecting and deselecting inventory (e.g., via the quantity picker 302) does not result in network traffic directed towards the commerce platform 102. Additionally, in some examples, actually purchasing the selected inventory cannot be accomplished through the cart interface 500 (e.g., purchasing is gated by proceeding to the checkout interface, etc.). As a result, a large number of users can simultaneously interact with a cart interface 500 instantiated entirely in their own browser without causing any network traffic to be directed towards the commerce platform 102. The checkout interface facilitates the browser receiving a calculation of actual cost of the selected inventory (via low processing-load backend calls to the commerce platform 102) and initiating purchase of the inventory (via interaction with a checkout button). Until an actual purchase of inventory is initiated (e.g., the user interacting with the checkout button), the checkout interface does not cause any queries into the IMS database 132.

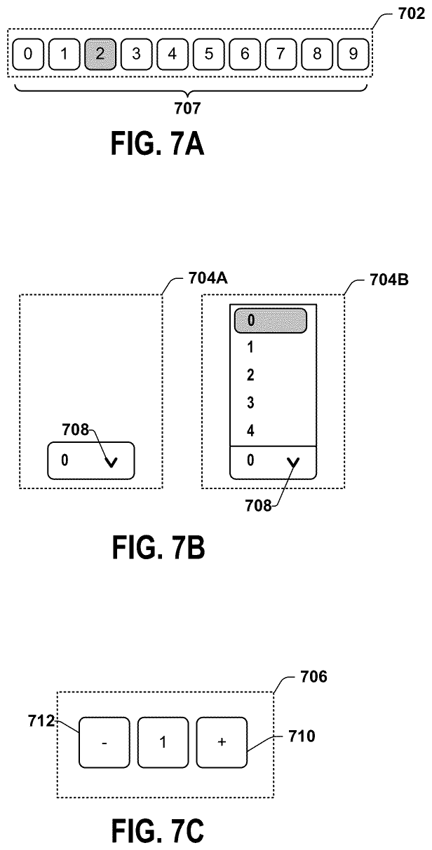

FIGS. 7A, 7B, and 7C illustrate example quantity pickers 702, 704B and 704B, and 706. The quantity pickers 700A, 700B, and 700C of FIGS. 7A, 7B, and 7C are examples of the quantity picker 302 of FIG. 3. FIG. 7A illustrates a number select quantity picker 702 that presents a definable series of mutually exclusive interface elements 707 with each element representing a quantity of goods. When a user interacts with one of the interface elements 707, the cart interface calculates an estimated total cost of the associated type and quantity without making a backend call. The merchant, via the packager 124, may define the numbers associated with each interface element 707 and the order in which those numbers appear. Additionally, the merchant may define a shape (e.g., a geometric shape) for interface elements 707. The size, shape and layout of the interface elements 707 may be contextual. When the offer package 120 is generated, the package-to-interface mapping rules 322 may configure the size, shape and layout of the interface elements 707 depending on whether the offer package 120 and script being downloaded by a desktop browser or a mobile browser, etc.

FIG. 7B illustrates an example drop down quantity picker 704A and 704B that presents a definable list of elements representing a quantity of goods. One drop down quantity picker 704A is illustrated in its passive state with a quantity selected. One drop down quantity picker 704B is illustrated in its active state showing the list of elements representing a quantity of goods. When a user interacts with one of the elements, the cart interface, to calculate an estimated total cost of the associated type and quantity without making a backend call. The merchant, via the packager 124, may define the elements available and their associated quantity in the drop down quantity picker 700B. In some examples, the drop down quantity picker 704A and 704B may be editable without the drop down quantity picker 704A transitioning into the active state. For example, the user may select the drop down quantity picker 704A without activating an interface element 708 and enter a valid quantity from a physical or virtual keyboard interface.

FIG. 7C illustrates an example plus-minus quantity picker 706. The example plus-minus quantity picker 706 include a positive interface element 710 and a negative interface element 712 that increase or decrease, respectively, the quantity being selected by the user. When a user interacts with one of the elements 710 and 712, the cart interface, to calculate an estimated total cost of the associated type and quantity without making a backend call. In some examples, the plus-minus quantity picker 706 may editable. For example, the user may select a numerical display element 714 on the plus-minus quantity picker 706 without activating either element 710 and 712 to enter a valid quantity from a physical or virtual keyboard interface.

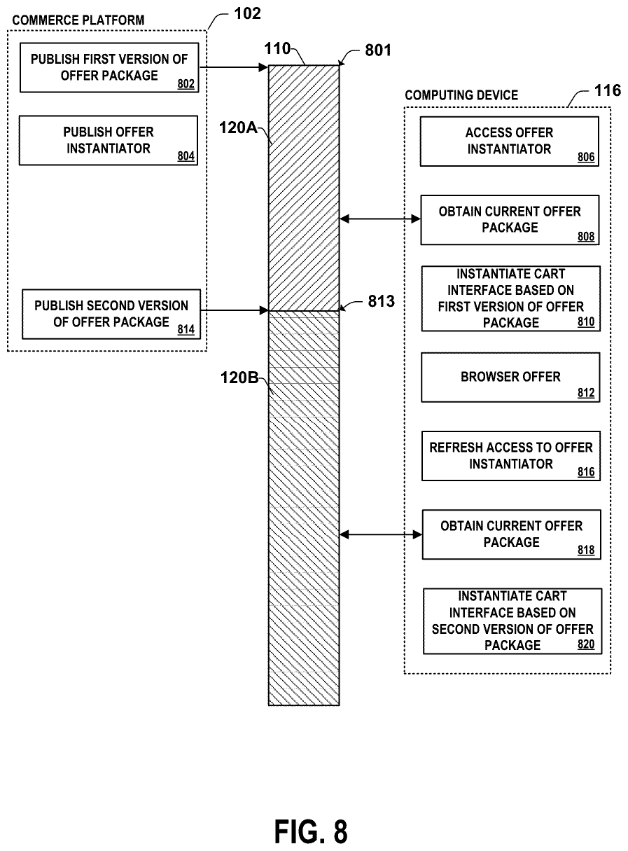

FIG. 8 illustrates an example method of asynchronously updating the offer package 120. The packager 124 may update the offer package 120A at any time without communicating that update directly to the computing device 116. FIG. 8 illustrates a conceptual state of the network storage 110 (and thus the network storage 112 of the CDN 114) at various points in time. While FIG. 8 shows one offer package 120A being updated, different versions of the offer package 120 (e.g., a version of mobile browsers, a version of desktop browsers, etc.) for the same offer may be updated asynchronously of each other. The packager 124 may, for example, (a) update the offer package 120A after receiving a manual update from the merchant 104 and/or (b) update the offer package 120A automatically after receiving (i) an update to the definition of one of the bricks 128 used to construct the offer package 120A (e.g., the template, the theme, the definitions used by the slicer 306 to slice the inventory 308, the quantity picker 302, etc.), (ii) an update to the inventory 308, (iii) an update to the input-to-package mapping rules 318, and/or (iv) an update to the package-to-interface mapping rules 322, etc. Pushing the update to the network storage 110 to be distributed to the CDN 114 is a relatively low network cost compared to (a) signaling the computing devices 116 currently instantiating the cart interface and/or (b) proactively rebuilding the cart interface on a server after an update and sending the rebuild cart interface to each of the computing devices 116 currently instantiating the cart interface. Thus, the commerce platform 102 can update the offer package 120A, as a result, the cart interface, during a surge of network traffic to adapt to changing conditions (e.g., availability of inventory, changes to the quantity picker 302, etc.) due to the surge of network traffic.

Initially, the commerce platform 102, via the packager 124, publishes a first version of the offer package 120A and a first version of the instantiating script at a first time 801 (e.g., as described in connection with FIGS. 3 and 4 above, etc.) (block 802). The commerce platform 102 also publishes the corresponding offer instantiator 118 (block 804). Thus, the network storage 110 and 112 includes copies of the first version of the offer package 120A and the first version of the instantiating script at or shortly after (e.g., accounting for distribution time, etc.) the first time 801.

At some time after the first time 801, the computing device(s) 116 access(es) the original offer instantiator 118 (block 806). In response to accessing the original offer instantiator 118, the browser operating on the computing device 116 makes a static call to one of the network storages 112 to retrieve that original offer package 120A and the original instantiating script (block 808). The browser operating on the computing device 116, using the resources of the computing device 116, generates the code and the style sheers to instantiate the cart interface using the first version of the instantiator script based on the first version of the offer package 120A (block 810). The user then browses the cart interface as described herein above (block 812).

At a second time 813 after the first time 811, the commerce platform 102 publishes a second version of the offer package 120B (e.g., as described in connection with FIGS. 3 and 4 above, etc.) (block 814). In some examples, the commerce platform 102 may also publish a second version of the instantiating script. Thus, the network storage 110 and 112 includes copies of the second version of the offer package 120A and, in some examples, the second version of the instantiating script at or shortly after (e.g., accounting for distribution time, etc.) the second time 813.

At some point after the second time 813, the browser refreshes access to the offer instantiator 118 (block 816). For example, the user may manually refresh the browser or the browser may receive an error signal causing the script to automatically refresh the browser from the commerce platform 102 instead of a calculated cost (as described above) in response to interacting with the action button 512. Such an error signal may be generated by the commerce platform 102 in response to the interacting with the action button 512, but not automatically at the second time 813 when the second version of the offer package 120B is published. Thus, such a signaling does not increase network traffic than already anticipated as is, like the actual cost calculation, done in response to an action by the user that indicates a higher level of intention towards the goods and/or services. In response to refreshing access to the offer instantiator 118, the browser operating on the computing device 116 makes a static call to one of the of network storages 112 to retrieve the second version of the offer package 120B and the instantiating script (block 818). The browser operating on the computing device 116, using the resources of the computing device 116, generates the code and the style sheers to instantiate the cart interface using the second version of the instantiator script based on the first version of the offer package 120B (block 820). The user then browses the cart interface as described herein above

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

1. A network traffic surge resistant system comprising:
network storage; and
one or more servers configured as a commerce platform configured to:
at a first time, generate a script, a first offer package, and an offer instantiator, and store the script and the first offer package onto the network storage, the offer instantiator providing the location of the script and the first offer package in the network storage; and
at a second time after the first time, generate a second offer package that is related to the first offer package and replace the first offer package with the second offer package in the same location in the network storage, wherein generating the second offer package does not cause the commerce platform to generate an update signal to any browsers;
wherein, in response to a browser operating on a computing device accessing the offer instantiator after the first time but before the second time:
causing, by the offer instantiator, the browser to retrieve the script and the first offer package from the network storage;
causing, by the script, the browser to instantiate a cart interface within the browser based on the first offer package using the resources of the computing device without making a backend call to the commerce platform, the cart interface including an action button; and
wherein, in response to the browser accessing the offer instantiator after the second time:
causing, by the offer instantiator, the browser to retrieve the second offer package from the network storage; and
causing, by the script, the browser to instantiate the cart interface within the browser based on the second offer package using the resources of the computing device without making a backend call to the commerce platform.

2. The system of claim 1, wherein the second offer package has at least one element changed from the first offer package.

3. The system of claim 1, wherein the first offer package defines an interface element to facilitate a user changing the quantity of a good or service currently present in the checkout interface.

4. The system of claim 3, wherein the interface element is a number select quantity picker.

5. The system of claim 4, wherein the script is to render the number select quantity picker with a first set of parameters when the browser is a mobile browser and a second set of parameters when the browser is a desktop browser.

6. The system of claim 3, wherein the interface element is a drop down quantity picker.

7. The system of claim 3, wherein the interface element is a plus-minus quantity picker.

8. The system of claim 1, wherein the first offer package includes a first list of goods or services to be made available via the cart interface such that browsing the goods and services in the cart interface does not cause the browser to make a backend call to the commerce platform.

9. The system of claim 1, wherein the second offer package includes a second list of goods or services to be made available via the cart interface such that browsing the goods and services in the cart interface does not cause the browser to make a backend call to the commerce platform, wherein the second list has fewer items than the first list.

10. The system of claim 1, wherein to cause the browser to instantiate the cart interface, the script generates instructions, using the resources of the computing device, for the browser to execute based on the first or second offer package.

11. A method for asynchronously updating a cart interface a network traffic surge resistant platform, the method comprising:
at a first time:
generating, by one or more servers configured as the network traffic surge resistant platform, a script, a first offer package, and an offer instantiator;
storing, by the one or more servers configured as the network traffic surge resistant platform, the script and the first offer package onto the network storage, the offer instantiator providing the location of the script and the first offer package in the network storage;
in response to a browser operating on a computing device accessing the offer instantiator after the first time but before a second time:
causing, by the offer instantiator, the browser to retrieve the script and the first offer package from the network storage;
causing, by the script, the browser to instantiate a cart interface within the browser based on the first offer package using the resources of the computing device without making a backend call to the commerce platform; and
at the second time after the first time:
generating, by the one or more servers configured as the network traffic surge resistant platform, a second offer package that is related to the first offer package; and
replacing, by the one or more servers configured as the network traffic surge resistant platform, the first offer package with the second offer package in the same location in the network storage, wherein generating the second offer package does not cause the commerce platform to generate an update signal to the browser;
in response to the browser accessing the offer instantiator after the second time:
causing, by the offer instantiator, the browser to retrieve the second offer package from the network storage; and
causing, by the script, the browser to instantiate the cart interface within the browser based on the second offer package using the resources of the computing device without making a backend call to the commerce platform.

12. The method of claim 11, wherein the second offer package has at least one element changed from the first offer package.

13. The method of claim 11, wherein the first offer package defines an interface element to facilitate a user changing the quantity of a good or service currently present in the checkout interface.

14. The method of claim 13, wherein the interface element is a number select quantity picker.

15. The method of claim 14, wherein the script is to render the number select quantity picker with a first set of parameters when the browser is a mobile browser and a second set of parameters when the browser is a desktop browser.

16. The method of claim 13, wherein the interface element is a drop down quantity picker.

17. The method of claim 13, wherein the interface element is a plus-minus quantity picker.

18. The method of claim 11, wherein the first offer package includes a first list of goods or services to be made available via the cart interface such that browsing the goods and services in the cart interface does not cause the browser to make a backend call to the commerce platform.

19. The method of claim 11, wherein the second offer package includes a second list of goods or services to be made available via the cart interface such that browsing the goods and services in the cart interface does not cause the browser to make a backend call to the commerce platform, wherein the second list has fewer items than the first list.

20. The method of claim 11, wherein causing the browser to instantiate the cart interface includes generating instructions, by the script, using the resources of the computing device, for the browser to execute based on the first or second offer package.
